(19) United States
(12) Patent Application Publication
(10) Pub. No.: US 2015/0188776 A1
(43) Pub. Date: Jul. 2, 2015

(54) SYNCHRONIZING USER INTERFACE ACROSS MULTIPLE DEVICES

(71) Applicant: KT CORPORATION, Gyeonggi-do (KR)

(72) Inventors: Sang-Wook LEE, Seoul (KR); Seung-Woo LEE, Seoul (KR)

(21) Appl. No.: 14/584,043

(22) Filed: Dec. 29, 2014

(30) Foreign Application Priority Data
Dec. 27, 2013 (KR) 10-2013-0165347

(51) Int. Cl. H04L 12/24; G06F 3/0484

(52) U.S. Cl. CPC H04L 41/22; G06F 3/04847

(57) ABSTRACT

Provided is a method of synchronizing with associated electronic devices to have a designated user interface. The method may include generating, by a first electronic device, user interface context information when a user input is received from a user to change at least one of properties of a current user interface of the first electronic device and transmitting, by the first electronic device, the generated user interface context information to at least one of the associated electronic devices.

### CROSS REFERENCE TO PRIOR APPLICATIONS

The present application claims priority under 35 U.S.C. §119 to Korean Patent Application No. 10-2013-0165347 (filed on Dec. 27, 2013).

### BACKGROUND

The present disclosure relates to a user interface and, more particularly, to synchronizing a user interface with multiple electronic devices.

Lately, an individual normally uses at least two or three electronic devices simultaneously. For example, an individual operates a microwave to steam peas and reads a recipe displayed on a tablet personal computer (PC) for preparing a dinner while watching TV. As describe, the individual performs three different tasks using three different electronic devices, the microwave, the tablet PC, and TV. For multitasking without interrupting one task for the other, an individual might control user interfaces (e.g., input type) of all electronic devices individually to recognize a voice input or a gesture input. Furthermore, if a smart phone is ringing when having both hands soaked with source after setting up the user interface of all other electronic devices to recognize a voice input, it could be very inconvenience to take a phone call through the smart phone. The user must set up the smart phone to recognize a voice input or a gesture input. After the multitasking, a user must switch back all electronic devices to a default user interface. Such manual setup operation is very annoying and inconvenient.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect, electronic devices may be synchronized to have a designated user interface upon generation of a predetermined event.

In accordance with another aspect, an electronic device may request other electronic devices to have a designated user interface upon receiving of a user input for changing at least one properties of a user input.

In accordance with still another aspect, an electronic device may change a user interface to a designated user interface based on information included in a request message when the electronic device receives the request message from others.

In accordance with at least one embodiment, a method may be provided for synchronizing with associated electronic devices to have a designated user interface. The method may include generating, by a first electronic device, user interface context information when a user input is received from a user to change at least one of properties of a current user interface of the first electronic device and transmitting, by the first electronic device, the generated user interface context information to at least one of the associated electronic devices.

The generating may include determining a service type of the current user interface having at least one property currently changed by the user, as service type information, obtaining information on the first electronic device as device information and information on the current user interface as user interface information, and generating the user interface context information by including the service type information, the device information, and the user interface information.

The determining may include determining the service type based on profile data stored in a memory of the first electronic device when the first electronic device is a single-purpose device and determining the service type based on active applications and contents being processed by the active applications when the first electronic device is a multi-purpose device.

The obtaining may include determining a user input type to recognize a user input received from the user based on properties of the current user interface and determining a user output type to output a result of a predetermined operation to a user based on properties of the current user interface.

The user input type may include at least one of a voice input type, a gesture input type, a touch input type, a text input type, a button input type, a keyboard input type, a motion input type, and a button input type. The user output type may include at least one of a voice output type, a vibration output type, and a display output type.

The transmitting may include selecting target electronic devices to transmit the generated user interface context information based on at least one of a distance from the first electronic device and a service type of the first electronic device, generating a synch request message to include the generated user interface context information, and transmitting the generated synch request message to the selected target electronic devices.

The selecting may include transmitting a request message to an associated home gateway to select electronic devices having a service type associated with the service type of the first electronic device, as the target electronic devices to transmit the generated user interface context information.

The generating may include determining whether a user input has been received after setting the at least one of properties of the current user interface and generating the user interface context information only when the user input has been received.

The generating may include detecting a user input to change a user input type of the current user interface and generating a synch request message including information on the changed user input type for requesting the associated electronic devices to have a designated user interface in association with the changed user input type.

In accordance with another embodiment, a method may be provided for synchronizing associated electronic devices to have a designated user interface. The method may include receiving, by a second electronic device, a synch request message including user interface context information from a first electronic device and changing, by the second electronic device, at least one property of a user interface of the second electronic device based on information on a user interface of the first electronic device, which is included in the received synch request message.

The method may further include extracting user interface context information from the synch request message, obtaining information on a requested service type and a requested user interface type from service type information and user interface information included in the extracted user interface context information, and selecting a target user interface based on the obtained information on the requested service type and the requested user interface type.

The method may further include obtaining a requested service type and a requested user interface type from the received synch request message, determining whether the second electronic device has a service type associated with the requested service type and whether the second electronic device supports the requested user interface type, and changing the current user interface of the second electronic device when the second electronic device has the associated service type and supports the requested user interface type.

The method may further include obtaining information on a requested user interface type from the received synch request message and selecting, as a target user interface, one associated with the requested user interface type from user interface types supported by the second electronic device. A current user interface of the second electronic device may be changed to the target user interface. The target user interface may be one of a same user interface as compared to the first electronic device and a user interface designated in association with the requested user interface type.

The method may further include determining whether the second electronic device receives any user input from a user after the changing and changing a changed user interface back to an original user interface when no user input is received. Otherwise, the changed user interface may be maintained.

The changing may include determining a requested user input type based on information included in the synch request message and changing a user input type of a current user interface to one of a requested user input type and a user input type designated in association with the requested user input type.

In accordance with still another embodiment, an electronic device may be provided for synchronizing with associated electronic devices to have a designated user interface. The electronic device may be configured to generate user interface context information upon receipt of a user input to change at least one of properties of the user interface and transmit the generated user interface context information to the associated electronic devices for requesting the associated electronic devices to have the designated user interface. The electronic device may be configured to receive a synch request message including user interface context information from one of the associated electronic devices and change at least one property of a current user interface based on information on a user interface of the one, which is included in the received synch request message.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 is an overview illustrating synchronizing multiple electronic devices to have the same user interfaces or a designated user interface in accordance with at least one embodiment;

FIG. 2 illustrates an electronic device for synchronizing a user interface with other electronic devices in accordance with at least one embodiment;

FIG. 3 illustrates determination of a service type in accordance with at least one embodiment;

FIG. 4 illustrates a table having information on a service type and corresponding electronic devices in accordance with at least one embodiment;

FIG. 5 illustrates context information in accordance with at least one embodiment;

FIG. 6 illustrates transmitting a synch request message in accordance with at least one embodiment;

FIG. 7 illustrates synchronization of user interfaces in accordance with at least one embodiment; and

FIG. 8 illustrates a method of synchronizing a user interface among electronic devices in accordance with at least one embodiment.

### DESCRIPTION OF EMBODIMENTS

Reference will now be made in detail to embodiments of the present disclosure, examples of which are illustrated in the accompanying drawings, wherein like reference numerals refer to like elements throughout. The embodiments are described below, in order to explain the present invention by referring to the figures.

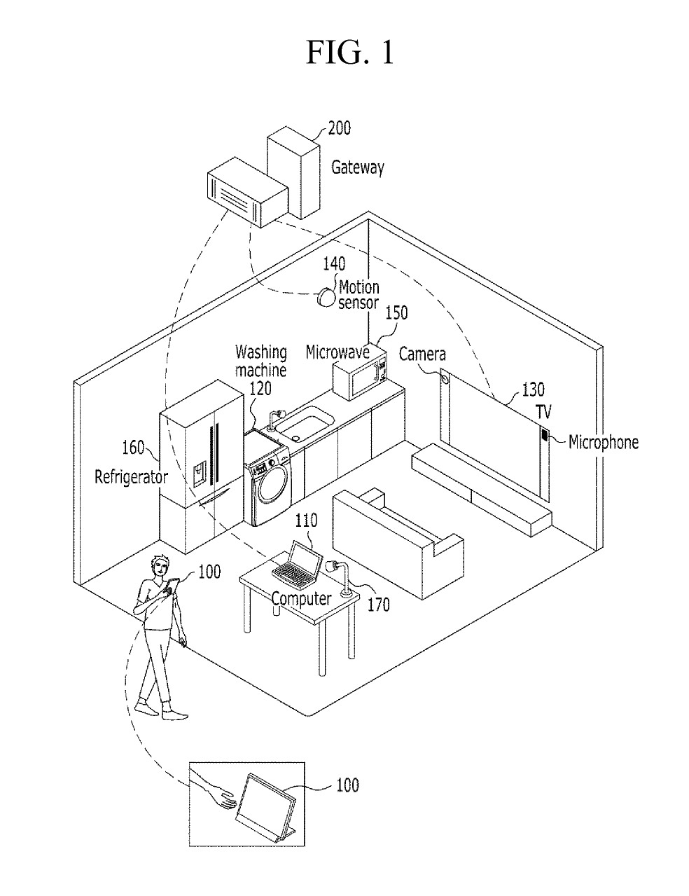

In accordance with at least one embodiment, a user interface of an electronic device may be synchronized with others upon generation of a predetermined event. In particular, electronic devices located at a predetermined area may be synchronized to have the same user interface or a designated user interface when at least one of the electronic devices changes a user interface including a user input type. Hereinafter, such a synchronization operation will be described with reference to FIG. 1.

FIG. 1 is an overview illustrating synchronizing multiple electronic devices to have the same user interface or a designated user interfaces in accordance with at least one embodiment.

Referring to FIG. 1, an electronic device (e.g., 100 to 170) may receive various types of inputs from a user, perform an operation designated by the received input, and provide the result of the operation to the user. That is, such an electronic device may interact with the user through a user interface to receive inputs and to provide results of operations performed based on the received inputs. For example, an electronic device may produce a user interface by executing an operating system based on settings controlled by the user and provide the produced user interface, such as a graphic user interface, through a predetermined output circuit. Such a user interface may be set to detect various types of inputs, such as a voice input, a touch input, a gesture input, a motion input, and so forth, from user and to provide results of operations in a user preferred scheme.

In accordance with at least one embodiment, electronic devices (e.g., 100 to 170) may be synchronized to have an identical user interface or a designated user interface upon generation of a predetermined event, such as detection of change in a user interface or receipt of a synch request message. In order to perform such synchronization, such electronic devices 100 to 160 may communicate with each other through a communication network. Such a communication network may be established through home gateway 200 or may be established directly between electronic devices. That is, as shown in FIG. 1, smart phone 100 may communicate with other electronic devices, such as personal computer 110, refrigerator 160, light 170, television set 130, washing machine 120, motion sensor 140, and microwave 150, which are grouped through home gateway 200 and forms a home automation network (e.g., smart home). That is, such electronic devices 100 to 170 may participate in a smart home network grouped by gateway 200. In this environment, electronic devices 100 to 170 may communicate to each other and be synchronized to have the same user interface or the designated user interface for interacting with an associated user upon generation of a predetermined event. However, the present invention is not limited to electronic devices included in the same home network. For example, any electronic devices supporting such a user interface synchronization function can be synchronized to have the same user interface or the designated user interface although such electronic devices are not included in the same home network group. In this case, electronic devices may communicate to each other through a direct link established between two electronic devices.

The electronic devices capable of user interface synchronization may be any electronic devices capable of i) interacting with a user through various input/output interfaces (e.g., user interfaces), ii) communicating with other entities through a communication network, iii) processing data for executing predetermined applications using data in a memory, and iv) storing data received from others and generated as results of processing. For example, the electronic device may include a smart phone, a computer, a smart home appliance, and so forth.

In accordance with at least one embodiment, such electronic device 100 may dynamically control a user interface to be synchronized with other electronic devices 110 to 170 upon generation of a predetermined event. For example, when electronic device 100 changes a user interface upon receipt of a user input, electronic device 100 may transmit a synch request message to others 110 to 170. When electronic device 100 receives a synch request message from others 110 to 170, electronic device 100 may change a user interface to be identical to that of others. The user interface may denote a type of receiving a user input. Such user input type may include a voice input, a gesture input, a text input, a button input, and so forth.

For synchronization of a user interface, electronic devices 100 to 170 may be installed with a predetermined application. Electronic devices 100 to 170 may execute the predetermined application upon turned on and initiate a synchronization operation upon generation of a predetermined event. After the initiation of the synchronization operation, electronic devices 100 to 170 may exchange information on a current user interface through a communication network, such as a wired network, a wireless network, a power line communication (PLC), a local area network (LAN), a value added network (VAN), a wide area network (WAN), a Bluetooth, a Wi-Fi, a an infrared (IR) communication, and a WI-Max. The present invention is not limited to one particular method of communication.

In order to efficiently synchronize user interfaces of electronic devices 100 to 170, electronic devices 100 to 170 may i) initiate such a synchronization operation (e.g., transmission of a synch request message) when an electronic device maintains a current user interface at least one for a predetermined time period without changing any properties of the current user interface, ii) detect electronic devices within a predetermined distance and request the detected electronic device to synchronize the user interface, and iii) select electronic devices capable of performing a similar function to provide a related service and request the selected electronic devices to synchronize the user interface.

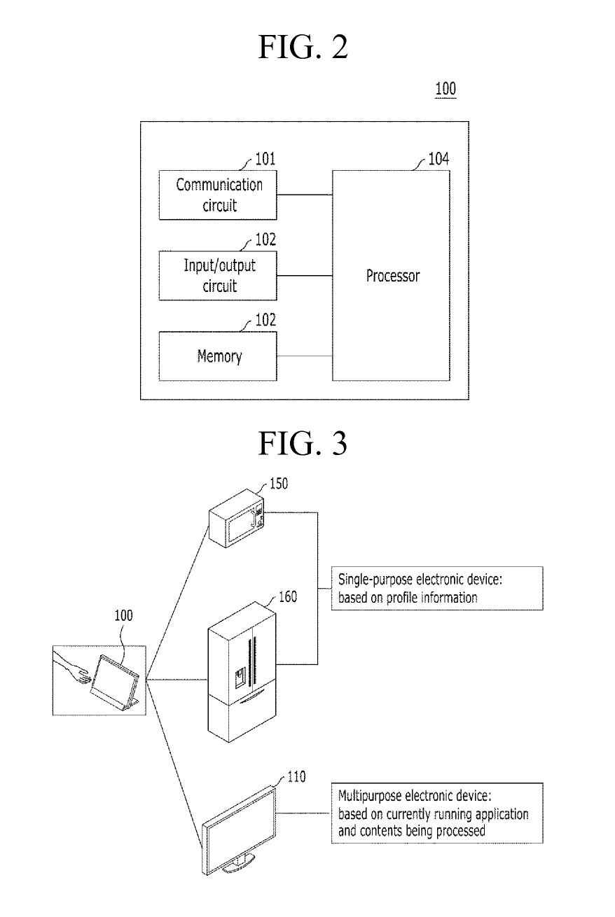

Hereinafter, an electronic device will be described with reference to FIG. 2. For convenience and ease of understanding, electronic device 100 will be used as a representative example to describe electronic devices 100 to 170. Particularly, only constituent elements related to a synchronization operation will be described. Accordingly, actual electronic device may have more elements as compared to one illustrated in FIG. 2.

FIG. 2 illustrates an electronic device for synchronizing a user interface with other electronic devices in accordance with at least one embodiment.

Referring to FIG. 2, electronic device 100 may include communication circuit 101, input/output circuit 102, memory 103, and processor 104. Communication circuit 101 may be a circuitry for enabling electronic device 100 to communicate with other entities including home gateway 200 and electronic devices 110 to 170 through a communication network based on various types of communication schemes. For example, communication circuit 101 may be referred to as a transceiver or a transmitter-receiver. In general, communication circuit 101 may transmit data to or receive data from other entities coupled to a communication network. For convenience and ease of understanding, electronic device 100 is illustrated as having one communication circuit in FIG. 2, but the present invention is not limited thereto. For example, electronic device 100 may include more than two communication circuits each employing different communication scheme. Communication circuit 101 may include at least one of a mobile communication circuit, a wireless internet circuit, a near field communication (NFC) circuit, a global positioning signal receiving circuit, and so forth. Particularly, communication circuit 101 may include a short distance communication circuit for short distance communication, such as NFC, and a mobile communication circuit for long range communication through a mobile communication network, such as long term evolution (LTE) communication or wireless data communication (e.g., WiFi).

In accordance with at least one embodiment, communication circuit 101 may receive a synch request message from other electronic devices 110 to 170 and provide the received synch request message to processor 104. In addition, communication circuit 101 may transmit a synch request message to other electronic devices 110 to 170 for requesting other electronic devices 110 to 170 to synchronize a user interface to be identical.

Input/output circuit 102 may be a circuitry for enabling electronic device 100 to receive a user input and output a result of processing a predetermined operation in response to the user input. For example, input/output circuit 102 may include a touch screen, a display, a keyboard, a button, a speaker, a microphone, and so forth. In accordance with at least one embodiment, input/output circuit 102 may receive a user input directly from a user or an operator. Such a user input may include any input for setting a new user interface, an input for changing one user interface to the other, an input for changing an input type to at least one of a touch input, a gesture input, a voice input, a text input, and a button input, an input for transmitting a synch request message, and so forth.

Memory 103 may be a circuitry for storing various types of digital data including an operating system, at least one application, information and data necessary for performing operations.

Processor 104 may be a central processing unit (CPU) that carries out the instructions of a predetermined program stored in memory 103 by performing basic arithmetic, logical, control and input/output operations specified by the instructions. In accordance with at least one embodiment, processor 104 may perform various types of operations for synchronizing user interfaces with others.

In accordance with at least one embodiment, processor 104 may perform operations as follows. Processor 104 may perform operations for i) generating context information based on a current user interface set by a user, ii) transmitting the generated context information to other electronic devices 110 to 170 through communication circuit 101, iii) receiving context information from other electronic device 110 to 170 through communication circuit 101, iv) deciding a user interface to use based on the received user interface information, and v) synchronizing a user interface by changing a current user interface to the decided user interface. Such operations may be performed through executing a designated software program (e.g., application or App) installed in electronic device 100, but the present invent is not limited thereto. For example, a processing circuit may be dedicatedly designed to perform the above operations and included in processor 104.

For generating the context information and transmitting the generated context information to others, electronic device 100 may perform following operations. First, a service type of a user interface may be determined. For example, a user interface of an electronic device may be set up for providing a designated service, such as reading a book, watching movie, listening music, browsing websites, and so forth. Furthermore, a user sets up or change properties of a user interface to conveniently and effectively use an electronic device to perform a designated operation, such as reading a book, listen to music, watching a movie, cooking, and so forth.

That is, based on the designated operation or service, a user sets up an input type for recognizing and receiving a user input and an output type for outputting a result of operations based on a user input. The input type may include at least one of a voice input type, a gesture input type, a text input type, a touch input type, a button input type, a keyboard input type, and so forth. The output type may include at least one of a voice output type, a vibration output type, and a display output type. In the voice input type, electronic device 100 may produce and provide a user interface to recognize and receive a voice input from a user. In the gesture input type, electronic device 100 may produce and provide a user interface to recognize and receive a gesture input from a user. In the voice output type, electronic device 100 may produce and provide a user interface to output a result of a designated operation in voice. In the vibration output type, electronic device 100 may produce and provide a user interface to output a result of a designated operation in vibration patterns. In the display output type, electronic device 100 may produce and provide a user interface to output a result of a designated operation through displaying information on input/output circuit 102.

As described, when a user changes or sets up at least one of properties of a user interface, electronic device 100 detects a service type of the user interface. Such a service type of the user interface may be determined based on profile information of electronic device 100 or information on active applications or contents currently running or processed in electronic device 100.

FIG. 3 illustrates determination of a service type in accordance with at least one embodiment. Referring to FIG. 3, electronic device 100 may be classified into a single-purpose device and a multipurpose device. The single-purpose device may denote an electronic device built for providing a single service, such as a refrigerator, a laundry machine, a television, an audio system, a light, and so forth. The multi-purpose device may denote an electronic device built for providing multiple services and functions, such as a smartphone, a desktop computer, a laptop computer, a tablet, and so forth.

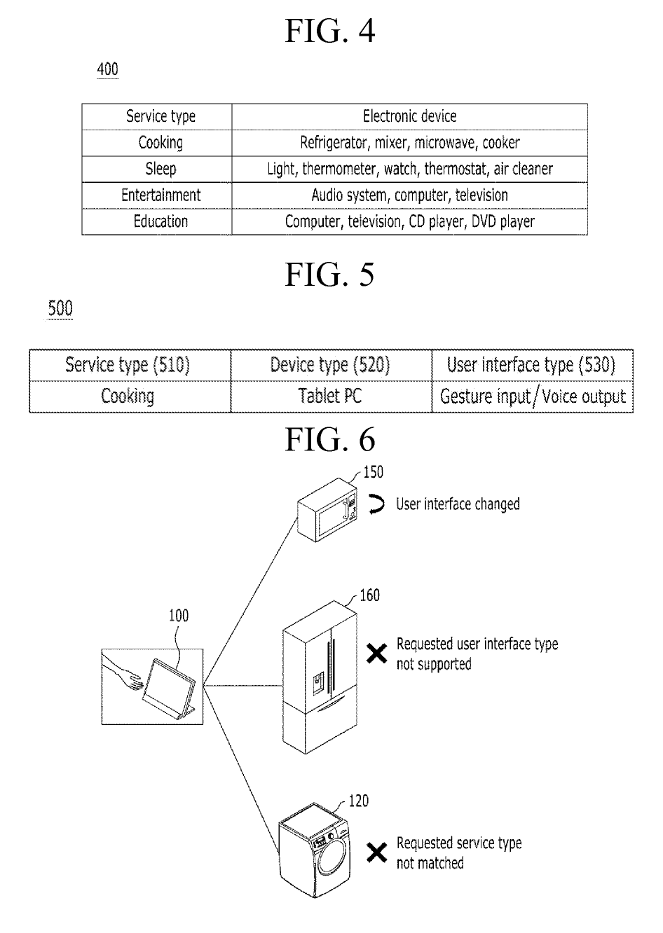

When electronic device 100 is a single-purpose device, processor 104 of electronic device 100 may perform operations of i) reading device profile information from memory 103 and ii) determining a service type of electronic device 100 based on the device profile. For example, a refrigerator may have profile information defining a service type as cooking and television may have profile information defining a service type as entertainment. Based on such profile information, a service type of electronic device 100 may be determined. Electronic device 100 may have at least one of service types of cooking, entertainment, sleep, education, and so forth. Such a service type may be defined by at least one of a system designer, an operator, a service provider, and a user. Such determination may be performed based on information stored in other electronic devices, such as home gateway 200. Home gateway 200 may include a table containing information on service types of electronic devices, as show in FIG. 4. Such a table will be described in more detail with reference to FIG. 4.

When electronic device 100 is a multi-purpose device, processor 104 of electronic device 100 may perform operations of i) analyzing active applications currently running and performing a designated operation, ii) analyzing contents being processed by the active applications, and iii) determining a service type of electronic device 100 based on the analysis result. For example, when a user uses electronic device 100 to browse and read a recipe, electronic device 100 may detect a web-browser as an active application and a recipe as contents to be processed. Based on such analysis, electronic device 100 determines a service type of an active user interface among service types predefined by at least one of a system designer, an operator, a user, and a service provider.

Second, target electronic devices to be synchronized may be selected. For example, processor 104 of electronic device 100 may perform operations for selecting electronic devices for transmitting a synch request message based on the determined service type. In generally, a user uses multiple electronic devices to perform a predetermined operation. For example, when a user prepares a dinner, the user usually use a refrigerator, a microwave, a computer, a cooker, and/or a mixer simultaneously. Accordingly, electronic device 100 may select electronic devices having a related service type or a same service type and transmit a synch request message to the selected electronic devices in accordance with at least one embodiment.

In order to select electronic devices having a similar or identical service type, electronic device 100 may use a table shown in FIG. 4. That is, information on a service type of each electronic device may be stored in and managed by a predetermined device, such as home gateway 200. For example, FIG. 4 illustrates a table having information on a service type and corresponding electronic devices in accordance with at least one embodiment. Referring to FIG. 4, service type 410 may be classified into cooking 411, sleep 412, entertainment 413, education 414, and so forth. Electronic devices having a service type of cooking 411 may include a refrigerator (e.g., 160), a mixer, a microwave (e.g., 150), and a cooker. Electronic devices having a service type of sleep 412 may include a light (e.g., 170), a thermometer, a watch, a thermostat, and an air cleaner. Electronic devices having a service type of entertainment 413 may include an audio system, a computer (e.g., 110), and a television (e.g., 130). Electronic devices having a service type of education 414 may include a computer (e.g., 110), a television (e.g., 130), a CD player, and a DVD player.

Such information may be stored and managed by home gateway 200. For example, when an electronic device registers at home gateway 200 for a related service, home gateway 200 may obtain information on the electronic device and classify the electronic device by a service type defined by at least one of a system designer, an operator, a service provider, and a user.

After determining a service type, electronic device 100 may refer to table 400 to select electronic devices to transmit a synch request message. In particular, electronic device 100 may download information on table 400 from home gateway 200 and refer to the downloaded information on table 400 to select electronic devices to transmit a synch request message. Alternatively, electronic device 100 may transmit a synch request message with information the determined service type to home gateway 200 for determining electronic devices having a similar or same service type. In response to the request message, electronic device 100 may receive a response message including information on electronic devices having a similar service type or the same service type.

As described, table 400 may be also used to determine a service type of electronic device 100. For example, electronic device 100 may obtain device information from a profile stored in memory 103, transmit the obtained device information to home gateway 200, and request home gateway 200 to determine a service type of electronic device 100. In response to the request, electronic device 100 receives a response message from home gateway 200 including the determined service type of electronic device 100.

As described, by referring to table 400, electronic device 100 may select other electronic devices to transmit a synch request message. For example, when electronic device 100 has a service type of cooking, electronic device 100 may select a refrigerator (e.g., 160 in FIG. 1), a mixer, a microwave, and a cooker.

Third, context information may be generated. For example, electronic device 100 may collect device information, service type information, and user interface information and generate context information based on the collected device information, the collected service type information, and the collected user interface information. When a user sets up a tablet personal computer (PC) to detect a gesture input, to read a recipe, and to output the result in voice, through a designated application, electronic device 100 may determine a service type of cooking based on the running application and contents processed by the running application, obtain device information (e.g., tablet PC) from memory 103, and collect information on a user interface, such as an input type (e.g., a gesture input) and an output type (e.g., voice output). Based on such analysis, electronic device 100 may generate context information. In particular, electronic device 100 may collect information on properties of a current user interface and include the collected user interface information (e.g., gesture input type, voice output type) in the synch request message. The user interface information may include information on an input type, an output type, a display resolution, a display layout, and so forth.

FIG. 5 illustrates context information in accordance with at least one embodiment. Referring to FIG. 5, context information 500 may include service type field 510, device type field 520, and user interface type field 530. Service type field 510 may include information on a determined service type, such as cooking. Device type field 520 may include information on a determined service type, such as a table PC. User interface type field 530 may include information on a determined user interface, such as at least one of a gesture input type and a voice output type.

Fourth, a synch request message may be transmitted. For example, electronic device 100 may generate a synch request message to include the context information. Electronic device 100 may transmit the generated synch request message to the selected electronic devices having the same service type, but the present invention is not limited thereto. For example, electronic device 100 may transmit the synch request message to electronic devices located around electronic device 100. In particular, electronic device 100 may detect electronic devices located within a predetermined distance and transmit the synch request message to the detected electronic device.

Furthermore, electronic device 100 may receive information on electronic devices to transmit a synch request message from a user. For example, electronic device 100 may produce, as a result of executing a designated application, a graphic user interface that enables a user to enter information on electronic devices to transmit a synch request message and display the produced graphic user interface on output circuit 102 of electronic device 100. Through the graphic user interface, electronic device 100 may receive information on the target electronic devices and store information on the target electronic device.

When electronic device 100 receives information on associated electronic devices, a user may register the associated electronic devices having a related service type as a group according to a pattern of using the associated electronic devices. In this case, electronic device 100 may select electronic devices included in the same group and transmit the synch request message to the selected electronic devices.

In addition, electronic device 100 may transmit the synch request message to home gateway 200 and home gateway 200 may transmit the received synch request message to associated electronic devices.

FIG. 6 illustrates transmitting a synch request message in accordance with at least one embodiment. Referring to FIG. 6, electronic device 100 may select microwave 150 and refrigerator 160 as electronic devices having the same service type and transmit a synch request message including context information 500 to the selected electronic devices. Or, electronic device 100 may transmit the synch request message including context information 500 to all of electronic devices (e.g., microwave 150, refrigerator 160, and washing machine 120) without selecting.

In case of microwave 150, microwave 150 may change a user interface to receive a gesture input from a user in response to the synch request message because microwave 150 has the same service type and has a user interface supporting the gesture input type. In case of refrigerator 160, refrigerator 160 does not change a user interface because refrigerator 160 does not have a user interfaced supporting the gesture input although refrigerator 160 has the same service type. In case of washing machine 120, washing machine 120 does not change a user interface because washing machine 120 does not have the same service type.

Fifth, a user interface may be set based on information included in a synch request message. For example, electronic device 100 may receive a synch request message from other electronic devices 110 to 170. In response to the synch request message, electronic device 100 may determine a user interface type and synchronize a current user interface to be matched with the determined user interface type.

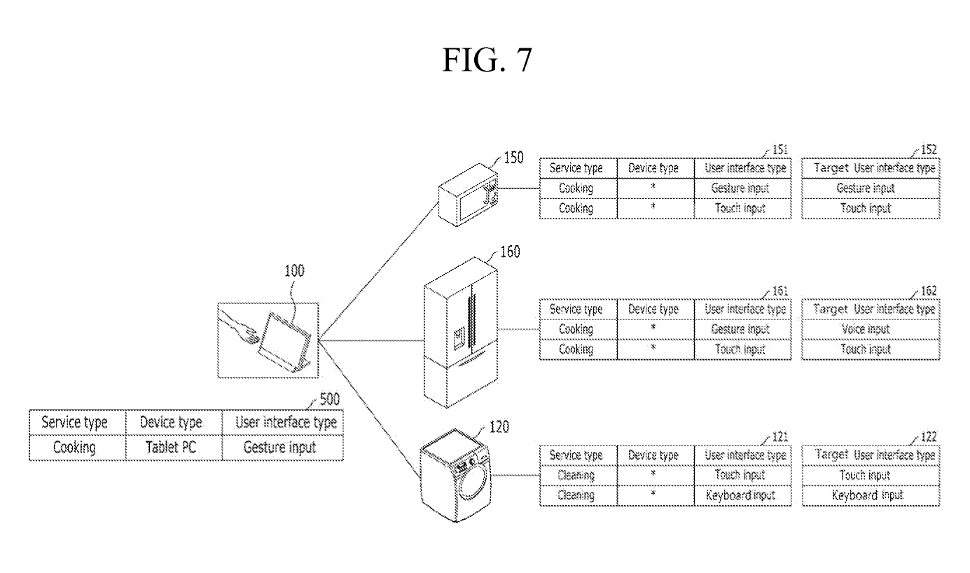

FIG. 7 illustrates synchronization of user interfaces in accordance with at least one embodiment. Referring to FIG. 7, tablet PC 100 may transmit a synch request message with context information 500 to microwave 150, refrigerator 160, and washing machine 120. As shown, context information 500 may include information on a service type as cooking, a device type as tablet PC, and a user interface type as a gesture input.

In case of microwave 150, microwave 150 may receive the synch request message from tablet PC 100 and determine a requested service type and a requested user interface type based on context information 500 in the synch request message. Microwave 150 may analyze own context information 151 and determine that the requested service type is matched with own service type and the requested user interface is supported. Then, microwave 150 may obtain information on a target user interface type to change based on target user interface type information 152. Accordingly, microwave 150 changes or maintains the user interface type to the gesture input type. Such a target user interface type may be set by at least one of a system designer, an operator, a service provider, and a user. In particular, the target user interface type may be set by a user and stored in a memory of a corresponding electronic device in connection with information on a corresponding requested user interface type. Alternatively, when a user registers a corresponding device at gateway 200, such target user interface type information may be stored in connection with a corresponding requested user interface type.

The present invention, however, is not limited to selecting a target user interface type based on target user interface type information (e.g., 152, 162, and 122). For example, an electronic device may change a user interface to be identical to the requested user interface type without obtaining information on a target user interface type.

In case of refrigerator 160, refrigerator 160 may receive the synch request message from tablet PC 100 and determine a requested service type and a requested user interface type based on context information 500 in the synch request message. Refrigerator 160 may analyze own context information 161 and determine that the requested service type is matched with own service type and determine that the requested user interface is supported. Then, refrigerator 160 may obtain information on a target user interface type to change based on target user interface type information 162. Accordingly, refrigerator 160 may change a user interface to the voice input type. In this case, user may control tablet PC 100 using a gesture input and control refrigerator 160 using a voice input. In addition, when an output type is changed to a voice output type, tablet PC 100 and refrigerator 160 may output a result of a predetermined operation in voice.

In case of washing machine 120, washing machine 120 may receive the synch request message from tablet PC 100 and determine a requested service type and a requested user interface type based on context information 500 in the synch request message. Washing machine 120 may analyze own context information 121 and determine that the requested service type is not matched with own service type and that the requested user interface is not supported. Accordingly, washing machine 120 terminates a synchronization operation.

After changing the user interface based on the synch request message, electronic device 100 may determine whether the changed user interface is valid. In particular, electronic device 100 determines whether a user input is received through the changed user interface after a second time period passes. When the user input is not received after the second time period passes, electronic device 100 determines that the changed user interface is invalid and changes the user interface back to the original user interface. When the user input is received after the second time period passes, electronic device 100 determines that the changed user interface is valid and maintains the changed user interface.

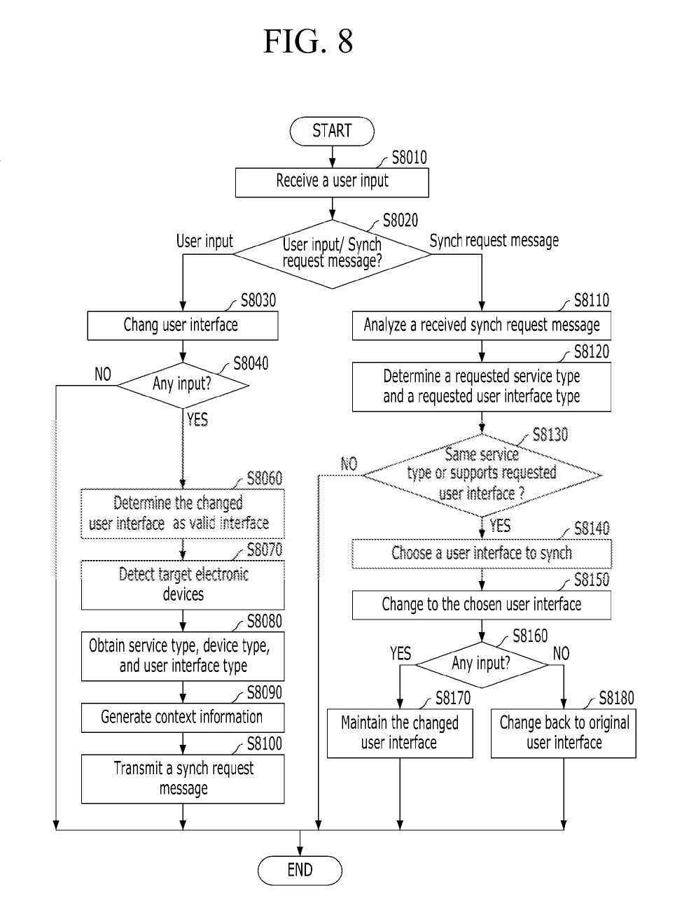

As described, electronic device 100 may synchronize a user interface with others. Hereinafter, such operation of electronic device 100 will be described with reference to FIG. 8.

FIG. 8 illustrates a method of synchronizing a user interface among electronic devices in accordance with at least one embodiment. Referring to FIG. 8, an input may be received at step S8010. For example, electronic device 100 may receive a user input from a user through input/output circuit 102 or receive a synch request message from other electronic devices 110 to 170 through communication circuit 101.

At step S8020, determination may be made so as whether the received input is a user input or a synch request message. For example, electronic device 100 may determine whether the received input is a user input for controlling or changing a user interface through input/output circuit 102 or a synch request message from other electronic devices 110 to 170 through communication circuit 101.

When the received input is the user input (User input—S8020), a currently running user interface may be changed based on the user input at step S8030. For example, electronic device 100 may analyze the user input and changes the currently running user interface based on the analysis result.

At step 8040, electronic device 100 may determine whether any user input has been received through the changed user interface after a first time period passes. When a user input is not received (No—S8040), electronic device 100 may determine the changed user interface is invalid to synchronize and terminate a user interface synchronization operation. When a user input is received (Yes-S8040), electronic device 100 may determine the changed user interface is valid and maintain the changed user interface to receive a user input at step S8060.

At step S8070, electronic device 100 may detect target electronic devices to transmit a synch request message. For example, electronic device 100 may detect electronic devices located within a predetermined distance as the target electronic devices, but the present invention is not limited thereto. As described, electronic device 100 may select such target electronic devices in various methods. Since such methods were described in detail with FIG. 3 and FIG. 4, the detailed description thereof is omitted herein.

At step S8080, electronic device 100 may obtain service type information, device type information, and user interface type information. For example, electronic device 100 may determine such information based on profile information stored in memory 103 or based on information on active applications and contents being processed.

At step S8090, electronic device 100 may generate context information as shown in FIG. 5 and generate a synch request message including the generated context information. At step S8100, electronic device 100 may transmit the generated synch request message to the selected electronic devices through communication circuit 101.

When the received input is the user input (Synch request message—S8020), electronic device 100 may analyze the received synch request message at step S8110. Based on the analysis result, electronic device 100 may determine a requested service type and a requested user interface based on context information included in the received synch request message at step S8120.

At step S8130, electronic device 100 may determine whether electronic device 100 provides the same service type as compared to the requested service type and supports the requested user interface.

When electronic device 100 provides the same service type and supports the requested user interface (Yes S8130), electronic device 100 may choose a user interface to be synchronized at step S8140. For example, electronic device 100 may choose the same user interface as the requested user interface type, but the present invention is not limited thereto. Electronic device 100 may choose a user interface different from the requested user interface based on information on a target user interface type, which is registered in connection with the requested user interface type.

At step S8150, electronic device 100 may change the current running user interface to the target user interface type. At step S8160, electronic device 100 may determine whether any user input is received through the changed user interface after a second time period passes. When a user input is received (Yes—S8160), electronic device 100 may determine the changed user interface is valid and maintain the changed user interface to receive a user input at step S8170. When a user input is not received (Yes-S8160), electronic device 100 may determine the changed user interface is invalid and changes the changed user interface back to the original user interface at step S8180.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a control server and the control server can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method of synchronizing with associated electronic devices to have a designated user interface, the method comprising:
generating, by a first electronic device, user interface context information upon generation of a predetermined event; and
transmitting, by the first electronic device, the generated user interface context information to at least one of the associated electronic devices.

2. The method of claim 1, wherein the generating comprises:
determining a service type of the first electronic device, as service type information;
obtaining information on the first electronic device as device information and information on a current user interface of the first electronic device as user interface information; and
generating the user interface context information by including the service type information, the device information, and the user interface information.

3. The method of claim 2, wherein the determining comprises:
determining the service type based on profile data stored in a memory of the first electronic device when the first electronic device is a single-purpose device; and
determining the service type based on active applications and contents being processed by the active applications when the first electronic device is a multi-purpose device.

4. The method of claim 2, wherein the obtaining comprises:
determining a user input type to recognize a user input received from the user based on properties of the current user interface; and
determining a user output type to output a result of a predetermined operation to a user based on properties of the current user interface.

5. The method of claim 2, wherein:
the user input type includes at least one of a voice input type, a gesture input type, a touch input type, a text input type, a button input type, a keyboard input type, a motion input type, and a button input type; and
the user output type includes at least one of a voice output type, a vibration output type, and a display output type.

6. The method of claim 1, wherein the transmitting comprises:
selecting target electronic devices to transmit the generated user interface context information based on at least one of a distance from the first electronic device and a service type of the first electronic device;
generating a synch request message to include the generated user interface context information; and
transmitting the generated synch request message to the selected target electronic devices.

7. The method of claim 6, wherein the selecting comprises:
transmitting a request message to an associated home gateway to select electronic devices having a service type associated with the service type of the first electronic device, as the target electronic devices to transmit the generated user interface context information.

8. The method of claim 1, wherein the generating comprises:
determining whether a user input has been received after setting the at least one of properties of the current user interface; and
generating the user interface context information only when the user input has been received.

9. The method of claim 1, wherein the generating comprises:
detecting a user input to change a user input type of the current user interface; and
generating a synch request message including information on the changed user input type for requesting the associated electronic devices to have a designated user interface in association with the changed user input type.

10. A method of synchronizing associated electronic devices to have a designated user interface, the method comprising:
receiving, by a second electronic device, a synch request message including user interface context information from a first electronic device; and
changing, by the second electronic device, at least one property of a user interface of the second electronic device based on information on a user interface of the first electronic device, which is included in the received synch request message.

11. The method of claim 10, comprising:
extracting user interface context information from the synch request message;
obtaining information on a requested service type and a requested user interface type from service type information and user interface information included in the extracted user interface context information; and
selecting a target user interface based on the obtained information on the requested service type and the requested user interface type.

12. The method of claim 10, comprising:
obtaining a requested service type and a requested user interface type from the received synch request message;
determining whether the second electronic device has a service type associated with the requested service type and whether the second electronic device supports the requested user interface type; and
changing the current user interface of the second electronic device when the second electronic device has the associated service type and supports the requested user interface type.

13. The method of claim 10, comprising:
obtaining information on a requested user interface type from the received synch request message; and
selecting, as a target user interface, one associated with the requested user interface type from user interface types supported by the second electronic device,
wherein a current user interface of the second electronic device is changed to the target user interface.

14. The method of claim 13, wherein the target user interface is one of a same user interface as compared to the first electronic device and a user interface designated in association with the requested user interface type.

15. The method of claim 10, comprising:
determining whether the second electronic device receives any user input from a user after the changing;
changing a changed user interface back to an original user interface when no user input is received;
otherwise, maintaining the changed user interface.

16. The method of claim 10, wherein the changing comprises:
determining a requested user input type based on information included in the synch request message; and
changing a user input type of a current user interface to one of a requested user input type and a user input type designated in association with the requested user input type.

17. The method of claim 10, wherein:
the synch request message includes user interface context information of the first electronic device;
the user interface context information includes information on at least one of a user input type and a user output type, changed by a user of the first electronic device;
the user input type includes at least one of a voice input type, a gesture input type, a touch input type, a text input type, a button input type, a keyboard input type, a motion input type, and a button input type; and
the user output type includes at least one of a voice output type, a vibration output type, and a display output type.

18. An electronic device of synchronizing with associated electronic devices to have a designated user interface, the electronic device configured to:
generate user interface context information upon generation of a predetermined event; and
transmit the generated user interface context information to the associated electronic devices for requesting the associated electronic devices to have the designated user interface.

19. The electronic device of claim 18, wherein the electronic device is configured to:
receive a synch request message including user interface context information from one of the associated electronic devices; and
change at least one property of a current user interface based on information on a user interface of the one, which is included in the received synch request message.

20. The electronic device of claim 18, wherein the electronic device is configured to:
obtain information on a requested user interface type from the received synch request message;
select, as a target user interface, one of a user interface identical to the requested user interface and a user interface designated in association with the requested user interface type from supported user interfaces; and
change a current user interface to the target user interface.

21. The method of claim 1, wherein the predetermined event includes at least one of:
receipt of a user input for changing at least one of properties of a current user interface of the first electronic device;
receipt of a synch request message;
maintaining of a current user interface for a predetermined time period;
expiration of a predetermined time duration; and
detection of a predetermined electronic device located within a predetermined distance from the first electronic device.

22. The electronic device of claim 18, wherein the predetermined event includes at least one of:
receipt of a user input for changing at least one of properties of a current user interface;
receipt of a synch request message;
maintaining of a current user interface for a predetermined time period;
expiration of a predetermined time duration; and
detection of a predetermined electronic device located within a predetermined distance from the electronic device.
